(19) United States
(12) Patent Application Publication
(10) Pub. No.: US 2012/0007564 A1
(43) Pub. Date: Jan. 12, 2012

(54) NONAQUEOUS ELECTROLYTE SECONDARY BATTERY AND METHOD FOR CHARGING THE SAME

(76) Inventors: Yoshiyuki Muraoka, Osaka (JP); Masaya Ugaji, Osaka (JP)

(21) Appl. No.: 13/257,138

(22) PCT Filed: Dec. 1, 2010
(86) PCT No.: PCT/JP2010/007017

§ 371 Date: Sep. 16, 2011

(30) Foreign Application Priority Data
Dec. 11, 2009 (JP) 2009-281590

(51) Int. Cl. H02J 7/00; H01M 4/131; H01M 4/62

(52) U.S. Cl. 320/137; 429/232; 429/223

(57) ABSTRACT

A nonaqueous electrolyte secondary battery includes: a positive electrode 1; and a negative electrode 2. When the battery is charged in an environment of 25° C. at a constant current of 0.7 C until a voltage value reaches 4.2 V, and is charged at a constant voltage of 4.2 V until a current value decreases to 0.05 C, capacity of the electrode per unit area is 3.5 mAh/cm² to 7.0 mAh/cm², both inclusive, and charge capacity of the negative electrode active material is 300 mAh/g to 330 mAh/g, both inclusive. Internal resistance of the battery is controlled in such a manner that the voltage value reaches 4.2 V when the battery is charged to 50% to 85%, both inclusive, of standard capacity in the environment of 25° C. at the constant current of 0.7 C.

### TECHNICAL FIELD

The present invention relates to nonaqueous electrolyte secondary batteries such as lithium ion secondary batteries etc., and a method for charging them.

### BACKGROUND ART

Nonaqueous electrolyte secondary batteries (hereinafter may be referred to as “batteries”) are secondary batteries having high operating voltage, and high energy density. Accordingly, nonaqueous electrolyte secondary batteries for small consumer devices have been and are being developed. Specifically, for example, the nonaqueous electrolyte secondary batteries have widely been used as power sources for driving portable electronic devices such as mobile phones, notebook computers, video cam recorders, etc. Today, not only the nonaqueous electrolyte secondary batteries for the small consumer devices, but also high power nonaqueous electrolyte secondary batteries for energy storage or electric vehicles have been and are being developed at a rapid pace.

### CITATION LIST

### Patent Documents

[Patent Document 1] Japanese Patent Publication No. H10-233205

[Patent Document 2] Japanese Patent Publication No. 2001-297763

### SUMMARY OF THE INVENTION

### Technical Problem

Attempts have been made to increase capacity of the battery by increasing capacity of an electrode per unit area. Further, reduction in time for charging the batteries has been pursued by quickly charging the batteries.

However, when a high capacity battery is quickly charged, lithium is deposited on a surface of a negative electrode, and a cycle characteristic of the battery is reduced. Further, an internal short circuit occurs in the battery due to lithium deposited on the surface of the negative electrode, which disadvantageously leads to reduction in safety of the battery.

A technology for improving the cycle characteristic of the nonaqueous electrolyte secondary battery has been proposed (see e.g., Patent Document 1). Patent Document 1 teaches that graphite powder which has an average particle diameter of 1-50 μm, and a specific surface area of 5-50 m²/g, and is formed into flakes of a thickness of 1 μm or smaller is used as a conductive agent. The conductive agent is added in an amount of 0.5-9.5% by mass relative to a positive electrode mixture.

A technology for improving the safety of the nonaqueous electrolyte secondary battery has been proposed (see e.g., Patent Document 2). Patent Document 2 teaches that lithium cobalt composite oxide having a resistance coefficient of 1 mΩ·cm to 40 mΩ·cm, both inclusive, when filling density of powder is 3.8 g/cm³, is used as a positive electrode active material.

However, the technologies taught by Patent Documents 1 and 2 are disadvantageous for the following reasons.

According to the technology of Patent Document 1, the cycle characteristic is improved in the following manner. Specifically, a highly conductive material is used as the conductive agent. Thus, electrons can uniformly and effectively be transferred to a positive electrode active material. This reduces the content of the conductive agent in the positive electrode mixture, and increases the content of the positive electrode active material, thereby improving the cycle characteristic of the battery.

However, as described later, the inventors of the present invention have found the following findings as a result of various studies. Specifically, in quickly charging a high capacity battery at a constant current and a constant voltage, internal resistance of the battery has to be controlled in such a manner that a voltage of the battery reaches a predetermined voltage when the battery is charged to 50% to 85%, both inclusive, of standard capacity for the purpose of reducing the reduction in cycle characteristic of the battery. Thus, even when the conductive agent is merely devised as described in Patent Document 1, lithium is deposited on the surface of the negative electrode, and the cycle characteristic of the battery cannot be sufficiently improved. Due to lithium deposited on the surface of the negative electrode, an internal short circuit occurs in the battery, thereby reducing the safety of the battery.

The technology of Patent Document 2 is directed to devise the positive electrode active material to improve the safety of the battery. According to the technology of Patent Document 2, the safety of the battery is improved in the following manner. Specifically, lithium cobalt composite oxide is used as the positive electrode active material. This can prevent reduction in energy density of the battery, and can reduce heat generation of the battery even when the battery falls into an abnormal state, thereby improving the safety of the battery.

In other words, the technology of Patent Document 2 is merely directed to improve the safety of the battery by reducing the heat generation of the battery. Thus, the deposition of lithium on the surface of the negative electrode cannot be reduced, and the cycle characteristic of the battery cannot be improved. Due to lithium deposited on the surface of the negative electrode, an internal short circuit occurs in the battery, thereby reducing the safety of the battery.

In view of the foregoing, the present invention is directed to reduce the reduction in cycle characteristic of a high capacity nonaqueous electrolyte secondary battery when the nonaqueous electrolyte secondary battery is quickly charged.

### Solution to the Problem

Through various studies, the inventors of the present invention have found that the cycle characteristic of the nonaqueous electrolyte secondary battery having high battery capacity is reduced when the nonaqueous electrolyte secondary battery is quickly charged at a constant current and a constant voltage for the following reason. As time for charging the battery passes, insertion of lithium ions in the negative electrode becomes less smooth. Thus, when time for charging the battery at a constant current is long (i.e., time until the voltage reaches a predetermined voltage in charging the battery at the constant current is long), the lithium ions cannot be inserted in the negative electrode, and lithium is deposited on the negative electrode, thereby reducing the cycle characteristic of the battery. The “charge at the constant current and the constant voltage” designates that the battery is charged at a constant current until the voltage reaches the predetermined voltage, and is charged at the constant voltage until the current reaches a predetermined current.

As a result of various studies, the inventors of the present invention have found the following findings. When a high capacity battery is quickly charged at the constant current and the constant voltage, it is important to control the internal resistance of the battery in such a manner that the voltage reaches the predetermined voltage when the battery is charged to 50% to 85%, both inclusive, of standard capacity at the constant current.

When time until the voltage reaches the predetermined voltage in charging the battery at the constant current (time for the charge at the constant current) is shortened, time for charging the battery at the constant current (at a high current) can be shortened, and the charge at the constant current can be switched to the charge at the constant voltage (i.e., charge at a decreasing current) in the case where the ease of insertion of the lithium ions in the negative electrode is gradually decreasing. This can reduce the deposition of lithium on the negative electrode, thereby reducing the reduction in cycle characteristic of the battery.

To achieve the above-described object_{;} a nonaqueous electrolyte secondary battery of the present invention includes: a positive electrode including a positive electrode current collector, and a positive electrode mixture layer which is provided on a surface of the positive electrode current collector, and contains a positive electrode active material; a negative electrode including a negative electrode current collector, and a negative electrode mixture layer provided on a surface of the negative electrode current collector; a porous insulating layer arranged between the positive electrode and the negative electrode; and a nonaqueous electrolyte solution, wherein when the battery is charged in an environment of 25° C. at a constant current of 0.7 C until a voltage value reaches 4.2 V, and is charged at a constant voltage of 4.2 V until a current value decreases to 0.05 C, capacity of the electrode per unit area is 3.5 mAh/cm² to 7.0 mAh/cm², both inclusive, and charge capacity of the negative electrode active material is 300 mAh/g to 330 mAh/g, both inclusive, and internal resistance of the battery is controlled in such a manner that the voltage value reaches 4.2 V when the battery is charged to 50% to 85%, both inclusive, of standard capacity in the environment of 25° C. at the constant current of 0.7 C.

According to the nonaqueous electrolyte secondary battery of the present invention, the internal resistance of the high capacity battery is controlled (e.g., is controlled to 40 mΩ to 55 mΩ, both inclusive). Thus, in charging the battery at the constant current, the voltage value can reach 4.2 V (predetermined voltage) when the battery is charged to 50% to 85%, both inclusive, of the standard capacity. Thus, the time for charging the battery at the constant current (at high current) can be reduced, and the charge at the constant current can be switched to the charge at the constant voltage (charge at decreasing current). Therefore, even when the high capacity battery is quickly charged at the constant current and the constant voltage, the deposition of lithium on the surface of the negative electrode can be reduced, thereby improving the cycle characteristic of the battery.

Further, even when the charge/discharge cycles are repeated, the deposition of lithium on the surface of the negative electrode can be reduced. Thus, the internal short circuit in the battery due to lithium deposited on the surface of the negative electrode is less likely to occur, thereby improving safety of the battery.

In the nonaqueous electrolyte secondary battery of the present invention, the internal resistance of the battery is preferably 40 mΩ to 55 mΩ, both inclusive.

This can control the voltage value to 4.2 V when the battery is charged to 50% to 85%, both inclusive, of the standard capacity at the constant current.

In the nonaqueous electrolyte secondary battery of the present invention, when the positive electrode is removed from the charged nonaqueous electrolyte secondary battery to form a first positive electrode sample and a second positive electrode sample, and the positive electrode mixture layer of the first positive electrode sample and the positive electrode mixture layer of the second positive electrode sample are brought into contact with each other, a resistance value between a terminal attached to the positive electrode current collector of the first positive electrode sample, and a terminal attached to the positive electrode current collector of the second positive electrode sample is preferably 0.2 Ω·cm² or higher. The resistance value is preferably 0.2 Ω·cm² to 4.0 Ω·cm², both inclusive.

In the nonaqueous electrolyte secondary battery of the present invention, the positive electrode preferably contains 100 parts by mass of the positive electrode active material, and 0.2 parts by mass to 1.25 parts by mass, both inclusive, of carbon. For example, the positive electrode mixture layer preferably contains a positive electrode active material, and a conductive agent, the conductive agent preferably contains carbon, and the positive electrode preferably contains 100 parts by mass of the positive electrode active material, and 0.2 parts by mass to 1.25 parts by mass, both inclusive, of the conductive agent. Specifically, the positive electrode active material preferably includes LiNi_{0.82}Co_{0.15}Al_{0.03}O₂, and the conductive agent preferably includes acetylene black.

With this configuration, the resistance value of the positive electrode can be controlled to, e.g., 0.2 Ω·cm² to 4.0 Ω·cm², both inclusive, by setting the amount of carbon (e.g., the amount of the conductive agent containing carbon) to, e.g., 0.2 parts by mass to 1.25 parts by mass, both inclusive.

To achieve the above-described object, the present invention provides a method for charging the nonaqueous electrolyte secondary battery of the present invention at a constant current and a constant voltage, wherein a constant current value for the charge at the constant current is 0.7 C or higher, and a constant voltage value for the charge at the constant voltage is 4.1 V or higher.

### Advantages of the Invention

According to the nonaqueous electrolyte secondary battery and the method for charging the same of the present invention, the deposition of lithium on the surface of the negative electrode can be reduced even when a battery having high battery capacity is quickly charged, thereby improving the cycle characteristic of the battery. Further, even when the charge/discharge cycles are repeated, the deposition of lithium on the surface of the negative electrode can be reduced. This can reduce the occurrence of an internal short circuit in the battery due to lithium deposited on the surface of the negative electrode, and can improve the safety of the battery.

### BRIEF DESCRIPTION OF THE DRAWINGS

FIG. 1 is a cross-sectional view illustrating the structure of a nonaqueous electrolyte secondary battery of an embodiment of the present invention.

FIG. 2 is a view illustrating measurement of a resistance value of a positive electrode.

### DESCRIPTION OF EMBODIMENTS

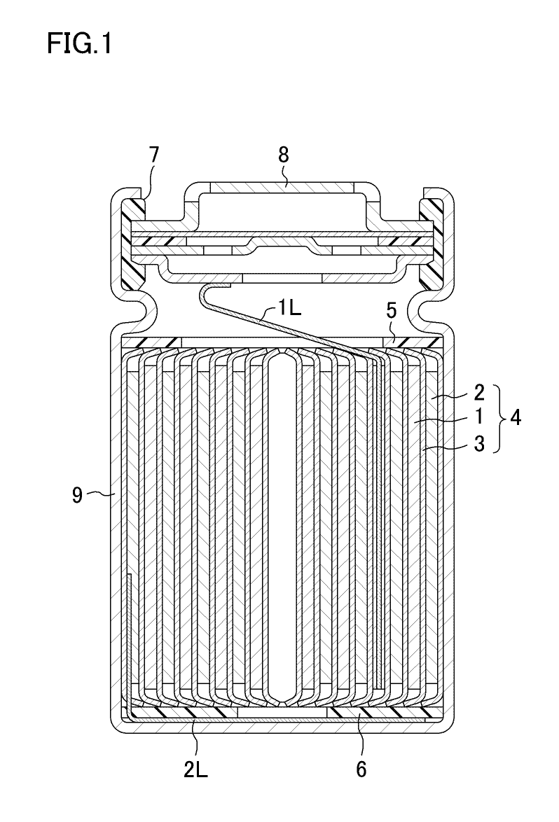

A nonaqueous electrolyte secondary battery of an embodiment of the present invention will be described below with reference to FIG. 1. FIG. 1 is a cross-sectional view illustrating the structure of the nonaqueous electrolyte secondary battery of the embodiment of the present invention.

The nonaqueous electrolyte secondary battery of the present embodiment (hereinafter referred to as “battery”) includes, as shown in FIG. 1, a positive electrode 1, a negative electrode 2, a porous insulating layer 3 arranged between the positive electrode 1 and the negative electrode 2, and a nonaqueous electrolyte solution.

As shown in FIG. 1, an electrode group 4 formed by winding the positive electrode 1 and the negative electrode 2 with the porous insulating layer 3 interposed therebetween is placed in a battery case 9 together with the nonaqueous electrolyte solution. An opening of the battery case 9 is sealed with a sealing plate 8 with a gasket 7 interposed therebetween. A positive electrode lead 1L attached to the positive electrode 1 is connected to the sealing plate 8 which functions as a positive electrode terminal, and a negative electrode lead 2L attached to the negative electrode 2 is connected to the battery case 9 which functions as a negative electrode terminal. An upper insulator 5 is arranged at an upper end of the electrode group 4, and a lower insulator 6 is arranged at a lower end of the electrode group 4.

The positive electrode 1 includes a positive electrode current collector, and a positive electrode mixture layer provided on surfaces of the positive electrode current collector. The positive electrode mixture layer contains a positive electrode active material, and a conductive agent. The positive electrode active material contains nickel capable of electrochemically inserting and extracting lithium ions.

The negative electrode 2 includes a negative electrode current collector, and a negative electrode mixture layer provided on surfaces of the negative electrode current collector. The negative electrode mixture layer contains a negative electrode active material. The negative electrode active material is capable of electrochemically inserting and extracting lithium ions.

When the battery of the present embodiment is charged in an environment of 25° C. at a constant current of 0.7 C until a voltage value reaches 4.2 V, and is charged at a constant voltage of 4.2 V until a current value decreases to 0.05 C, capacity of the electrode per unit area is 3.5 mAh/cm² to 7.0 mAh/cm², both inclusive. When the battery is charged at the constant current and the constant voltage described above, charge capacity is 300 mAh/g to 330 mAh/g, both inclusive. In other words, the battery of the present embodiment is a high capacity battery.

In the above charge at the constant current, internal resistance of the battery is controlled in such a manner that the voltage value reaches 4.2 V when the battery is charged to 50% to 85%, both inclusive, of standard capacity. Specifically, the internal resistance of the battery is controlled to adjust a capacity ratio to be 50% to 85%, both inclusive. The “capacity ratio” is calculated by the following [formula 1]. In the [formula 1], “capacity when the charge at the constant current is finished” designates capacity when the voltage value has reached 4.2 V through the charge at the constant current, and “standard capacity” designates a reference value of an amount of electricity obtained from a fully charged battery.

Capacity ratio (%)=capacity when the charge at the constant current is finished/standard capacity [formula 1]

When the internal resistance of the battery is controlled to, for example, 40 mΩ to 55 mΩ, both inclusive, the capacity ratio can be controlled to 50% to 85%, both inclusive.

When a resistance value of the positive electrode is controlled to, for example, 0.2 Ω·cm² to 4.0 Ω·cm², both inclusive, resistance of the electrode group can be controlled to, for example, 25 mΩ to 40 mΩ, both inclusive. The resistance of the electrode group increases with increase in resistance value of the positive electrode.

When the positive electrode contains 100 parts by mass of the positive electrode active material, and 0.2 parts by mass to 1.25 parts by mass, both inclusive, of carbon (e.g., a conductive agent containing carbon), the resistance value of the positive electrode can be controlled to 0.2 Ω·cm² to 4.0 Ω·cm², both inclusive. The resistance value of the positive electrode increases with decrease in amount of carbon contained in the positive electrode (e.g., the conductive agent containing carbon). The positive electrode active material may include, for example, LiNi_{0.82}Co_{0.15}Al_{0.03}O₂. The conductive agent may include, for example, acetylene black.

In the present embodiment, the internal resistance of the high capacity battery is controlled (e.g., is controlled to 40 mΩ to 55 mΩ, both inclusive). Thus, in charging the battery at the constant current, the voltage value can reach 4.2 V when the battery is charged to 50% to 85%, both inclusive, of the standard capacity. Specifically, the capacity ratio can be controlled to 50% to 85%, both inclusive. Thus, time for charging the battery at the constant current (at high current) can be reduced, and the charge at the constant current can be switched to the charge at the constant voltage (charge at a decreasing current). This can reduce deposition of lithium on a surface of the negative electrode even when the high capacity battery is quickly charged at the constant current and the constant voltage, thereby improving a cycle characteristic of the battery.

Even when the charge/discharge cycles are repeated, the deposition of lithium on the surface of the negative electrode can be reduced. This can reduce the occurrence of an internal short circuit in the battery due to lithium deposited on the surface of the negative electrode, thereby improving safety of the battery.

As a result of various studies, the inventors of the present invention have found that controlling the capacity ratio to 50% to 85%, both inclusive, by controlling the internal resistance of the battery can reduce the reduction in cycle characteristic of the high capacity battery when the battery is quickly charged at the constant current and the constant voltage. Table 1 shows the results.

The “high capacity battery” described in the specification of the present application designates batteries which satisfy a condition 1) that capacity of the electrode per unit area is 3.5 mAh/cm² to 7.0 mAh/cm², both inclusive, when the battery is charged at the constant current and the constant voltage, and a condition 2) that charge capacity of the negative electrode active material is 300 mAh/g to 330 mAh/g, both inclusive, when the battery is charged at the constant current and the constant voltage. Batteries which satisfy the condition 1) are shown in Table 2, and batteries which satisfy the condition 2) are shown in Table 3.

Regarding the battery of the present invention, a relationship between the internal resistance of the battery and the capacity ratio, and a relationship between the capacity ratio and the cycle characteristic of the battery will be described with reference to Batteries 1-6 and Batteries A and B.

### EXAMPLE 1

### (Battery 1)

Internal resistance of Battery 1 was 45 mΩ, resistance of an electrode group was 25 mΩ, and component resistance was 20 mΩ (internal resistance of the battery=resistance of the electrode group+component resistance).

A positive electrode had a resistance value of 0.2 Ω·cm².

When Battery 1 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 1 was charged to 75% of standard capacity in the environment of 25° C. at the constant current of 0.7 C, the voltage value reached 4.2 V.

Battery capacity was 2.8 Ah.

A method for fabricating Battery 1 will be described below.

### (Fabrication of Positive Electrode)

A mixed solution was prepared by mixing 1.25 parts by mass of acetylene black as a conductive agent, and a solution prepared by dissolving 1.7 parts by mass of polyvinylidene fluoride (PVDF) as a binder in a N-methyl pyrrolidone (NMP) solvent. Then, to the mixed solution, 100 parts by mass of LiNi_{0.82}Co_{0.15}Al_{0.03}O₂ as a positive electrode active material was mixed to obtain paste containing a positive electrode mixture. The paste was then applied to both surfaces of a 15 μm thick aluminum foil as a positive electrode current collector, and was dried. Then, the aluminum foil on which the paste was applied and dried was rolled and cut to obtain a positive electrode.

### (Fabrication of Negative Electrode)

Artificial graphite flakes were pulverized and classified to have an average particle diameter of about 20 μm. Then, 100 parts by mass of the artificial graphite flakes as a negative electrode active material, 3 parts by mass of styrene/butadiene rubber as a binder, and 100 parts by mass of an aqueous solution containing 1% by mass of carboxymethyl cellulose as a thickener were mixed to obtain paste containing a negative electrode mixture. Then, the paste was applied to both surfaces of a 8 μm thick copper foil as a negative electrode current collector, and was dried. The copper foil on which the paste was applied and dried was rolled and cut to obtain a negative electrode.

### (Preparation of Nonaqueous Electrolyte Solution)

To a mixed solvent prepared by mixing Ethylene carbonate (EC) and dimethyl carbonate (DMC) as nonaqueous solvents in a volume ratio of 1:3, 5% by mass of vinylene carbonate was added as an additive for increasing charge/discharge efficiency of the battery. LiPF₆ as an electrolyte was dissolved in the mixed solvent in a concentration of 1.4 mol/L to prepare a nonaqueous electrolyte solution.

### (Fabrication of Cylindrical Battery)

An aluminum positive electrode lead was attached to the positive electrode current collector, and a nickel negative electrode lead was attached to the negative electrode current collector. Then, the positive electrode and the negative electrode were wound with a polyethylene separator (a porous insulating layer) interposed therebetween to form an electrode group. An upper insulator was arranged at an upper end of the electrode group, and a lower insulator was arranged at a lower end of the electrode group. The negative electrode lead was welded to a battery case, the positive electrode lead was welded to a sealing plate having an internal pressure-operated safety valve, and the electrode group was placed in the battery case. Then, the nonaqueous electrolyte solution was injected into the battery case under reduced pressure. An open end of the battery case was crimped to the sealing plate with a gasket interposed therebetween to obtain a battery. The battery fabricated in this way was referred to as Battery 1.

### (Battery 2)

Internal pressure of Battery 2 was 45 mΩ, resistance of an electrode group was 30 mΩ, and component resistance was 15 mΩ.

A positive electrode had a resistance value of 2.5 Ω·cm².

When Battery 2 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 2 was charged to 75% of standard capacity in the environment of 25° C. at the constant current of 0.7 C, the voltage value reached 4.2 V.

A method for fabricating Battery 2 will be described below.

### (Fabrication of Positive Electrode)

A positive electrode was fabricated in the same manner as that of Battery 1 except that 0.6 parts by mass of acetylene black was used as the conductive agent in place of 1.25 parts by mass of acetylene black.

### (Fabrication of Negative Electrode)

A negative electrode was fabricated in the same manner as that of Battery 11.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 15 mΩ. The fabricated battery was referred to as Battery 2.

### Battery 3

Internal resistance of Battery 3 was 45 mΩ, resistance of an electrode group was 35 mΩ, and component resistance was 10 mΩ.

A positive electrode had a resistance value of 3.0 Ω·cm².

When Battery 3 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 3 was charged to 75% of standard capacity in the environment of 25° C. at the constant current of 0.7 C, the voltage value reached 4.2 V.

A method for fabricating Battery 3 will be described below.

### (Fabrication of Positive Electrode)

A positive electrode was fabricated in the same manner as that of Battery 1 except that 0.4 parts by mass of acetylene black was used as the conductive agent in place of 1.25 parts by mass of acetylene black.

### (Fabrication of Negative Electrode)

A negative electrode was fabricated in the same manner as that of Battery 1.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 10 mΩ. The fabricated battery was referred to as Battery 3.

### (Battery 4)

Internal resistance of Battery 4 was 45 mΩ resistance of an electrode group was 40 mΩ, and component resistance was 5 mΩ.

A positive electrode had a resistance value of 4.0 Ω·cm².

When Battery 4 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 4 was charged to 75% of standard capacity in the environment of 25° C. at the constant current of 0.7 C, the voltage value reached 4.2 V.

A method for fabricating Battery 4 will be described below.

### (Fabrication of Positive Electrode)

A positive electrode was fabricated in the same manner as that of Battery 1 except that 0.2 parts by mass of acetylene black was used as the conductive agent in place of 1.25 parts by mass of acetylene black.

### (Fabrication of Negative Electrode)

A negative electrode was fabricated in the same manner as that of Battery 1.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 5 mΩ. The fabricated battery was referred to as Battery 4.

### (Battery 5)

Internal resistance of Battery 5 was 55 mΩ, resistance of an electrode group was 40 mΩ (=the resistance of the electrode group of Battery 4), and component resistance was 15 mΩ (>the component resistance of Battery 4).

A positive electrode had a resistance value of 4.0 Ω·cm² (=the resistance value of the positive electrode of Battery 4).

When Battery 5 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 5 was charged to 50% of standard capacity in the environment of 25° C. at the constant current of 0.7 C, the voltage value reached 4.2 V.

A method for fabricating Battery 5 will be described below.

### (Fabrication of Positive Electrode)

A positive electrode was fabricated in the same manner as that of Battery 4. Specifically, the positive electrode was fabricated in the same manner as that of Battery 1 except that 0.2 parts by mass of acetylene black was used as the conductive agent in place of 1.25 parts by mass of acetylene black.

### (Fabrication of Negative Electrode)

A negative electrode was fabricated in the same manner as that of Battery 1.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 15 mΩ. The fabricated battery was referred to as Battery 5.

### (Battery 6)

Internal resistance of Battery 6 was 40 mΩ, resistance of an electrode group was 25 mΩ (=the resistance of the electrode group of Battery 1), and component resistance was 15 mΩ (<the component resistance of Battery 1).

A positive electrode had a resistance value of 0.2 Ω·cm² (=the resistance value of the positive electrode of Battery 1).

When Battery 6 was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery 6 was charged to 85% of standard capacity in the environment of 25° C. at the constant current of 0.7 C, the voltage value reached 4.2 V.

A method for fabricating Battery 6 will be described below.

### (Fabrication of Positive Electrode)

A positive electrode was fabricated in the same manner as that of Battery 1.

### (Fabrication of Negative Electrode)

A negative electrode was fabricated in the same manner as that of Battery 1.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 15 mΩ. The fabricated battery was referred to as Battery 6.

### COMPARATIVE EXAMPLE 1

### (Battery A)

Internal resistance of Battery A was 35 mΩ, resistance of an electrode group was 20 mΩ, and component resistance was 15 mΩ.

A positive electrode had a resistance value of 0.05 Ω·cm².

When Battery A was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery A was charged to 90% of standard capacity in the environment of 25° C. at the constant current of 0.7 C, the voltage value reached 4.2 V.

Battery capacity was 2.8 Ah.

A method for fabricating Battery A will be described below.

### (Fabrication of Positive Electrode)

A positive electrode was fabricated in the same manner as that of Battery 1 except that 3.0 parts by mass of acetylene black was used as the conductive agent in place of 1.25 parts by mass of acetylene black.

### (Fabrication of Negative Electrode)

A negative electrode was fabricated in the same manner as that of Battery 11.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 15 mΩ. The fabricated battery was referred to as Battery A.

### (Battery B)

Internal resistance of Battery B was 65 mΩ, resistance of an electrode group was 40 mΩ, and component resistance was 25 mΩ.

A positive electrode had a resistance value of 4.0 Ω·cm².

When Battery B was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 320 mAh/g. When Battery B was charged to 40% of standard capacity in the environment of 25° C. at the constant current of 0.7 C, the voltage value reached 4.2 V.

A method for fabricating Battery B will be described below.

### (Fabrication of Positive Electrode)

A positive electrode was fabricated in the same manner as that of Battery 4. Specifically, the positive electrode was fabricated in the same manner as that of Battery 1 except that 0.2 parts by mass of acetylene black was used as the conductive agent in place of 1.25 parts by mass of acetylene black.

### (Fabrication of Negative Electrode)

A negative electrode was fabricated in the same manner as that of Battery 11.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 25 mΩ. The fabricated battery was referred to as Battery B.

### —Measurement—

### (Internal Resistance of Battery)

The internal resistances of Batteries 1-6, A, and B, and Batteries 7 and C-I described later were measured. Specifically, impedance at a frequency of 1 kHz was measured.

### (Resistance of Electrode Group)

The resistances of the electrode groups of Batteries 1-6, A, and B, and Batteries 7 and C-I described later were measured. Specifically, for example, each of the batteries was disassembled to remove the electrode group, and impedance at a frequency of 1 kHz between the positive electrode terminal and the negative electrode terminal was measured.

### (Component Resistance)

The component resistances of Batteries 1-6, A, and B, and Batteries 7 and C-I described later were measured. Specifically, for example, the component resistance was obtained by subtracting the resistance of the electrode group from the internal resistance of the battery.

### (Resistance Value of Positive Electrode)

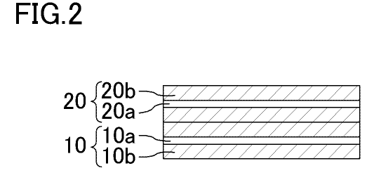

The resistance values of the positive electrodes of Batteries 1-6, A, and B, and Batteries 7 and C-I described later were measured. A method for measuring the resistance value will be described below with reference to FIG. 2. FIG. 2 is a view illustrating the measurement of the resistance value of the positive electrode.

Batteries 1-6, A, and B, and Batteries 7 and C-I described later were charged. Specifically, for example, Batteries 1-6, A, and B, and Batteries 7 and C-I described later were charged at a constant current of 1.45 A until a voltage reached 4.2 V, and were charged at a constant voltage of 4.2 V until a current reached 50 mA.

Then, Batteries 1-6, A, and B, and Batteries 7 and C-I described later were disassembled to remove the positive electrodes. Specifically, for example, Batteries 1-6, A, and B, and Batteries 7 and C-I described later were disassembled to remove the positive electrodes. Then, ethylene carbonate (EC) and an electrolyte etc. adhered to the positive electrodes were removed using dimethyl carbonate (DMC). Then, the positive electrodes were dried under vacuum at normal temperature.

Then, the resistance values of the positive electrodes were measured. Specifically, for example, each of the positive electrodes was cut to form first and second positive electrode samples 10 and 20 of 2.5 cm×2.5 cm. Then, a surface of a positive electrode mixture layer 10b and a surface of a positive electrode mixture layer 20b were brought into contact with each other. With humidity set to 20% or lower, and environmental temperature set to 20° C., a voltage generated when a current was flowed between the positive electrode current collector 10a and the positive electrode current collector 20a was measured by a four-terminal method under a pressure of 9.8 ×10⁵ N/m², thereby calculating a direct current resistance value. The direct current resistance value was introduced in the following [formula 2] to calculate the resistance value of the positive electrode. As indicated by [formula 2], the direct current resistance value was multiplied by an area in which the surfaces of the positive electrode mixture layers are in contact with each other (=2.5×2.5), and the product was divided by 2. As shown in FIG. 2, the measurement was performed with the two positive electrode samples in contact with each other. Therefore, the product of the direct current resistance value and the area was divided by 2.

Resistance value of positive electrode={direct current resistance value (2.5 ×2.5)}÷2 [formula 2]

### (Battery Capacity)

Batteries 1 and A, and Batteries 7 and C-1 described later were charged in an environment of 25° C. at a constant current of 1.4 A until a voltage reached 4.2 V, were charged at a constant voltage of 4.2 V until a current reached 50 mA, and were discharged at a constant current of 0.56 A until the voltage decreased to 2.5 V to obtain battery capacities.

### —Evaluation—

### (Cycle Characteristic of Battery)

Batteries 1-6, A, and B, and Batteries 7 and C-I described later were charged and discharged repeatedly. Specifically, for example, Batteries 1-6, A, and B, and Batteries 7 and C-I described later were charged in the environment of 25° C. at a constant current of 2030 mA (0.7 C) until the voltage value reached 4.2 V, were charged at a constant voltage of 4.2 V until the current value reached 50 mA, and were discharged at a constant current of 2.9 A (1 C) until the voltage value decreased to 2.5 V. The two charges and one discharge constituted a single cycle, and the cycle was repeated 500 times. Thus, Batteries 1-6, A, B, and Batteries 7 and C-I described later were repeatedly charged and discharged.

A capacity retention rate after the 500 cycles was calculated by the following [formula 3].

Capacity retention ratio (%)=capacity after the 500^{th} cycles/capacity after the 1^{st} cycle [formula 3]

Table 1 shows the internal resistance of the battery, the resistance of the electrode group, the component resistance, the resistance value of the positive electrode, the amount of the conductive agent, the capacity of the electrode per unit area, the charge capacity of the negative electrode active material, the capacity ratio, and the capacity retention rate of each of Batteries 1-6, A, and B.

TABLE 1

| | | | | Resistance | | | | | |
|---|---|---|---|---|---|---|---|---|---|
| | Internal | Resistance of | | value of | Amount of | Capacity | | | Capacity |
| | resistance of | electrode | Component | positive | conductive | per unit | Charge | Capacity | retention |
| | battery | group | resistance | electrode | agent | area | capacity | ratio | rate |
| Battery | mΩ | mΩ | mΩ | mΩ · cm² | wt % | mAh/cm² | mAh/g | % | % |
| Battery 1 | 45 | 25 | 20 | 0.2 | 1.25 | 3.5 | 320 | 75 | 75 |
| Battery 2 | 45 | 30 | 15 | 2.5 | 0.6 | 3.5 | 320 | 75 | 78 |
| Battery 3 | 45 | 35 | 10 | 3.0 | 0.4 | 3.5 | 320 | 75 | 82 |
| Battery 4 | 45 | 40 | 5 | 4.0 | 0.2 | 3.5 | 320 | 75 | 85 |
| Battery 5 | 55 | 40 | 15 | 4.0 | 0.2 | 3.5 | 320 | 50 | 80 |
| Battery 6 | 40 | 25 | 15 | 0.2 | 1.25 | 3.5 | 320 | 85 | 70 |
| Battery A | 35 | 20 | 15 | 0.05 | 3.0 | 3.5 | 320 | 90 | 40 |
| Battery B | 65 | 40 | 25 | 4.0 | 0.2 | 3.5 | 320 | 40 | 45 |

### —Comparison—

### (Batteries 1-4)

As shown in Table 1, the resistance value of the positive electrode increases with the increase in amount of the conductive agent. The resistance of the electrode group increases with the increase in resistance value of the positive electrode.

The component resistance is reduced by reducing the resistance of PTC.

As shown in Table 1, when the internal resistance of the battery is 45 mΩ, and the battery is charged at the constant current to 75% of the standard capacity, the voltage value can reach 4.2 V. That is, the capacity ratio can be controlled to 75%.

### (Comparison Between Battery 4 and Battery 5)

As shown in Table 1, Battery 5 shows high internal resistance of the battery because the component resistance is higher than that of Battery 4. Battery 5 shows the capacity ratio lower than that of Battery 4.

As shown in Table 1, when the internal resistance of the battery is 55 mΩ, the capacity ratio can be controlled to 50%. This indicates that the capacity ratio decreases with the increase in internal resistance of the battery.

### (Comparison Between Battery 1 and Battery 6)

As shown in Table 1, Battery 6 shows low internal resistance of the battery because the component resistance is lower than that of Battery 1. Battery 6 shows the capacity ratio higher than that of Battery 1.

As shown in Table 1, when the internal resistance of the battery is 40 mΩ, the capacity ratio can be controlled to 85%. This indicates that the capacity ratio increases with the decrease in internal resistance of the battery.

### (Comparison Between Battery 2 and Battery A)

As compared with Battery A, Battery 2 contains less conductive agent, and shows high resistance value of the positive electrode. Thus, Battery 2 shows high resistance of the electrode group, and high internal resistance of the battery. Battery 2 shows the capacity ratio lower than that of Battery A. Battery 2 shows the capacity retention rate higher than that of Battery A.

As compared with Battery 2, the capacity ratio of Battery A is too high because the internal resistance of the Battery A is too low. Thus, time required for the charge at the constant current is too long, and lithium is deposited on the surface of the negative electrode. This presumably reduces the cycle characteristic of the battery.

This indicates that the capacity ratio is preferably lower than 90% (85% or lower).

### (Comparison Between Battery 4 and Battery B)

Battery 4 shows low internal resistance of the battery because the component resistance is lower than that of Battery B. Battery 4 shows the capacity ratio higher than that of Battery B. Battery 4 shows the capacity retention rate higher than that of Battery B.

As compared with Battery 4, the capacity ratio of Battery B is too low because the internal resistance of Battery B is too high. Since the internal resistance of Battery B is too high, the cycle characteristic of the battery may be reduced.

This indicates that the capacity ratio is preferably higher than 40% (50% or higher).

As indicated by the above results, controlling the internal resistance of the battery (e.g., in the range of 40 mΩ to 55 mΩ, both inclusive) allows control of the capacity ratio in the range of 50% to 85%, both inclusive. With the capacity ratio controlled in the range of 50% to 85%, both inclusive, the capacity retention rate can be increased (e.g., 65% or higher), thereby improving the cycle characteristic of the battery.

Regarding the battery of the present invention, a relationship between the capacity of the electrode per unit area and the cycle characteristic of the battery, and a relationship between the capacity of the electrode per unit area and the battery capacity will be described with reference to Battery 1 and Batteries A, and C-E.

### COMPARATIVE EXAMPLE 2

### (Battery C)

Internal resistance of Battery C was 45 mΩ, resistance of an electrode group was 25 mΩ, and component resistance was 20 mΩ.

A positive electrode had a resistance value of 0.2 Ω·cm².

When Battery C was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 340 mAh/g. When Battery C was charged to 75% of standard capacity in the environment of 25° C. at the constant current of 0.7 C, the voltage value reached 4.2 V.

Battery capacity was 2.9 Ah.

A method for fabricating Battery C will be described below.

### (Fabrication of Positive Electrode)

A positive electrode was fabricated in the same manner as that of Battery 1.

### (Fabrication of Negative Electrode)

A negative electrode was fabricated in the same manner as that of Battery 1 except that an amount of a negative electrode active material relative to an amount of a positive electrode active material per unit area was reduced.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1, and the fabricated battery was referred to as Battery C.

### (Battery D)

Internal resistance of Battery D was 45 mΩ, resistance of an electrode group was 25 mΩ, and component resistance was 20 mΩ.

A positive electrode had a resistance value of 0.2 Ω·cm².

When Battery D was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 280 mAh/g. When Battery D was charged to 75% of standard capacity in the environment of 25° C. at the constant current of 0.7 C, the voltage value reached 4.2 V.

Battery capacity was 2.65 Ah.

A method for fabricating Battery D will be described below.

### (Fabrication of Positive Electrode)

A positive electrode was fabricated in the same manner as that of Battery 1.

### (Fabrication of Negative Electrode)

A negative electrode was fabricated in the same manner as that of Battery 1 except that an amount of a negative electrode active material relative to an amount of a positive electrode active material per unit area was increased.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1. The fabricated battery was referred to as Battery D.

### (Battery E)

Internal resistance of Battery E was 35 mΩ, resistance of an electrode group was 20 mΩ, and component resistance was 15 mΩ.

A positive electrode had a resistance value of 0.05 Ω·cm².

When Battery E was charged in an environment of 25° C. at a constant current of 0.7 C until a voltage value reached 4.2 V, and was charged at a constant voltage of 4.2 V until a current value decreased to 0.05 C, capacity of an electrode per unit area was 3.5 mAh/cm², and charge capacity of a negative electrode active material was 280 mAh/g. When Battery E was charged to 90% of standard capacity in the environment of 25° C. at the constant current of 0.7 C, the voltage value reached 4.2 V.

Battery capacity was 2.65 Ah.

A method for fabricating Battery E will be described below.

### (Fabrication of Positive Electrode)

A positive electrode was fabricated in the same manner as that of Battery A. Specifically, the positive electrode was fabricated in the same manner as that of Battery 1 except that 3.0 parts by mass of acetylene black was used as the conductive agent in place of 1.25 parts by mass of acetylene black.

### (Fabrication of Negative Electrode)

A negative electrode was fabricated in the same manner as that of Battery 1 except that an amount of a negative electrode active material relative to an amount of a positive electrode active material per unit area was increased.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 15 mΩ. The fabricated battery was referred to as Battery E.

Table 2 shows the internal resistance of the battery, the resistance of the electrode group, the component resistance, the resistance value of the positive electrode, the amount of the conductive agent, the capacity of the electrode per unit area, the charge capacity of the negative electrode active material, the capacity ratio, the capacity retention rate, and battery capacity of each of Batteries 1, A, and C-E.

TABLE 2

| | | | | Resistance | | | | | | |
|---|---|---|---|---|---|---|---|---|---|---|
| | Internal | Resistance of | | value of | Amount of | Capacity | | | Capacity | |
| | resistance of | electrode | Component | positive | conductive | per unit | Charge | Capacity | retention | Battery |
| | battery | group | resistance | electrode | agent | area | capacity | ratio | rate | capacity |
| Battery | mΩ | mΩ | mΩ | mΩ · cm² | wt % | mAh/cm² | mAh/g | % | % | Ah |
| Battery 1 | 45 | 25 | 20 | 0.2 | 1.25 | 3.5 | 320 | 75 | 75 | 2.8 |
| Battery A | 35 | 20 | 15 | 0.05 | 3.0 | 3.5 | 320 | 90 | 40 | 2.8 |
| Battery C | 45 | 25 | 20 | 0.2 | 1.25 | 3.5 | 340 | 75 | 10 | 2.9 |
| Battery D | 45 | 25 | 20 | 0.2 | 1.25 | 3.5 | 280 | 75 | 80 | 2.65 |
| Battery E | 35 | 20 | 15 | 0.05 | 3.0 | 3.5 | 280 | 90 | 80 | 2.65 |

### —Comparison—

### (Comparison Between Battery 1 and Battery C)

The charge capacity of the negative electrode active material of Battery 1 is 320 mAh/g. The charge capacity of the negative electrode active material of Battery C is 340 mAh/g. The battery capacity of Battery 1 is lower than that of Battery C. The capacity retention rate of Battery 1 is higher than that of Battery C.

The internal resistance of Battery 1 is the same as that of Battery C. The capacity ratio of Battery 1 is the same as that of Battery C. The capacity of the electrode per unit area of Battery 1 is the same as that of Battery C.

The capacity ratio of Battery C is the same as that of Battery 1 (in the range of 50% to 85%, both inclusive). However, the capacity retention rate of Battery C is lower than that of Battery 1. A presumable reason for this result is as follows. When the charge capacity of the negative electrode active material exceeds 330 mAh/g, the charge capacity exceeds theoretical capacity of carbon as the negative electrode material, and lithium is deposited on the surface of the negative electrode. This leads to abrupt reduction of the cycle characteristic of the battery.

This indicates that the charge capacity of the negative electrode active material is preferably lower than 340 mAh/g (330 mAh/g or lower).

### (Comparison Between Battery 1 and Battery D)

The charge capacity of the negative electrode active material of Battery 1 is 320 mAh/g. The charge capacity of the negative electrode active material of Battery D is 280 mAh/g. The battery capacity of Battery 1 is higher than that of Battery D.

The internal resistance of Battery 1 is the same as that of Battery C. The capacity ratio of Battery 1 is the same as that of Battery D. The capacity of the electrode per unit area of Battery 1 is the same as that of Battery D.

Both of Batteries 1 and D show high capacity retention rate.

Like Battery 1, Battery D shows the capacity ratio in the range of 50% to 85%, both inclusive. Thus, Battery D has high capacity retention rate like Battery 1. However, since the charge capacity of the negative electrode active material of Battery D is 280 mAh/g (lower than 300 mAh/g), the battery capacity of Battery D is lower than that of Battery 1. Thus, high battery capacity cannot be obtained.

This indicates that the charge capacity of the negative electrode active material is preferably higher than 280 mAh/g (300 mAh/g or higher).

This indicates that the charge capacity of the negative electrode active material is preferably in the range of 300 mAh/g to 330 mAh/g, both inclusive.

### (Comparison Between Battery A and Battery E)

The charge capacity of the negative electrode active material of Battery A is 320 mAh/g. The charge capacity of the negative electrode active material of Battery E is 280 mAh/g. The battery capacity of Battery A is higher than that of Battery E. The capacity retention rate of Battery A is lower than that of Battery E.

The internal resistance of Battery A is the same as that of Battery E. The capacity ratio of Battery A is the same as that of Battery E. The capacity of the electrode per unit area of Battery A is the same as that of Battery E.

Like Battery A, the Battery E shows the capacity ratio of 90% (higher than 85%). The capacity retention rate of Battery E is higher than that of Battery A. However, since the charge capacity of the negative electrode active material of Battery E is 280 mAh/g (lower than 300 mAh/g), the battery capacity of Battery E is lower than that of Battery A. Thus, high battery capacity cannot be obtained.

This indicates that the cycle characteristic of the battery may be reduced when the capacity ratio of Battery A having high battery capacity is 90% (higher than 85%). However, the cycle characteristic of the battery is not reduced when the capacity ratio of Battery E having low battery capacity is 90% (higher than 85%). Specifically, to reduce the reduction of the cycle characteristic of the battery having high battery capacity, it is important to control the capacity ratio in the range of 50% to 85%, both inclusive.

Regarding the battery of the present invention, a relationship between the charge capacity of the negative electrode active material and the cycle characteristic of the battery, and a relationship between the charge capacity of the negative electrode active material and the battery capacity will be described with reference to Batteries 1 and 7, and Batteries A and F-I.

### EXAMPLE 2

### (Battery 7)

Internal resistance of Battery 7 was 45 mΩ, resistance of an electrode group was 27 mΩ, and component resistance was 18 mΩ.

A positive electrode had a resistance value of 0.2 Ω·cm².

When Battery 7 was charged in an environment of 25° C. at a constant current of 0.7 C until a voltage value reached 4.2 V, and was charged at a constant voltage of 4.2 V until a current value decreased to 0.05 C, capacity of an electrode per unit area was 7.0 mAh/cm², and charge capacity of a negative electrode active material was 320 mAh/g. When Battery 7 was charged to 75% of standard capacity in the environment of 25° C. at the constant current of 0.7 C, the voltage value reached 4.2 V.

Battery capacity was 3.3 Ah.

A method for fabricating Battery 7 will be described below.

### (Fabrication of Positive Electrode)

A positive electrode was fabricated in the same manner as that of Battery 1 except that an amount of an active material per unit area of the positive electrode was increased.

### (Fabrication of Negative Electrode)

A negative electrode was fabricated in the same manner as that of Battery 1 except that an amount of an active material per unit area of the negative electrode was increased.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 18 mΩ. The fabricated battery was referred to as Battery 7.

### COMPARATIVE EXAMPLE 3

### (Battery F)

Internal resistance of Battery F was 35 mΩ, resistance of an electrode group was 22 mΩ, and component resistance was 13 mΩ.

A positive electrode had a resistance value of 0.05 Ω·cm².

When Battery F was charged in an environment of 25° C. at a constant current of 0.7 C until a voltage value reached 4.2 V, and was charged at a constant voltage of 4.2 V until a current value decreased to 0.05 C, capacity of an electrode per unit area was 7.0 mAh/cm², and charge capacity of a negative electrode active material was 320 mAh/g. When Battery F was charged to 90% of standard capacity in the environment of 25° C. at the constant current of 0.7 C, the voltage value reached 4.2 V.

Battery capacity was 3.3 Ah.

A method for fabricating Battery F will be described below.

### (Fabrication of Positive Electrode)

A positive electrode was fabricated in the same manner as that of Battery A except that an amount of an active material per unit area of the positive electrode was increased.

### (Fabrication of Negative Electrode)

A negative electrode was fabricated in the same manner as that of Battery 1 except that an amount of an active material per unit area of the negative electrode was increased.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 13 mΩ. The fabricated battery was referred to as Battery F.

### (Battery G)

Internal resistance of Battery G was 45 mΩ, resistance of an electrode group was 28 mΩ, and component resistance was 17 mΩ.

A positive electrode had a resistance value of 0.2 Ω·cm².

When Battery G was charged in an environment of 25° C. at a constant current of 0.7 C until a voltage value reached 4.2 V, and was charged at a constant voltage of 4.2 V until a current value decreased to 0.05 C, capacity of an electrode per unit area was 7.5 mAh/cm², and charge capacity of a negative electrode active material was 320 mAh/g. When Battery G was charged to 75% of standard capacity in the environment of 25° C. at the constant current of 0.7 C, the voltage value reached 4.2 V.

Battery capacity was 3.35 Ah.

A method for fabricating Battery G will be described below.

### (Fabrication of Positive Electrode)

A positive electrode was fabricated in the same manner as that of Battery 1 except that an amount of an active material per unit area of the positive electrode was increased.

### (Fabrication of Negative Electrode)

A negative electrode was fabricated in the same manner as that of Battery 1 except that an amount of an active material per unit area of the negative electrode was increased.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 17 mΩ. The fabricated battery was referred to as Battery G.

### (Battery H)

Internal resistance of Battery H was 45 mΩ, resistance of an electrode group was 24 mΩ, and component resistance was 21 mΩ.

A positive electrode had a resistance value of 0.2 Ω·cm².

When Battery H was charged in an environment of 25° C. at a constant current of 0.7 C until a voltage value reached 4.2 V, and was charged at a constant voltage of 4.2 V until a current value decreased to 0.05 C, capacity of an electrode per unit area was 3.0 mAh/cm², and charge capacity of a negative electrode active material was 320 mAh/g. When Battery H was charged to 75% of standard capacity in the environment of 25° C. at the constant current of 0.7 C, the voltage value reached 4.2 V.

Battery capacity was 2.7 Ah.

A method for fabricating Battery H will be described below.

### (Fabrication of Positive Electrode)

A positive electrode was fabricated in the same manner as that of Battery 1 except that an amount of an active material per unit area of the positive electrode was reduced.

### (Fabrication of Negative Electrode)

A negative electrode was fabricated in the same manner as that of Battery 1 except that an amount of an active material per unit area of the negative electrode was reduced.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 21 mΩ. The fabricated battery was referred to as Battery H.

### (Battery I)

Internal resistance of Battery I was 35 mΩ, resistance of an electrode group was 19 mΩ, and component resistance was 16 mΩ.

A positive electrode had a resistance value of 0.05 Ω·cm².

When Battery I was charged in an environment of 25° C. at a constant current of 0.7 C until a voltage value reached 4.2 V, and was charged at a constant voltage of 4.2 V until a current value decreased to 0.05 C, capacity of an electrode per unit area was 3.0 mAh/cm², and charge capacity of a negative electrode active material was 320 mAh/g. When Battery I was charged to 90% of standard capacity in the environment of 25° C. at the constant current of 0.7 C, the voltage value reached 4.2 V.

Battery capacity was 2.7 Ah.

A method for fabricating Battery I will be described below.

### (Fabrication of Positive Electrode)

A positive electrode was fabricated in the same manner as that of Battery A except that an amount of an active material per unit area of the positive electrode was reduced.

### (Fabrication of Negative Electrode)

A negative electrode was fabricated in the same manner as that of Battery 1 except that an amount of an active material per unit area of the negative electrode was reduced.

### (Preparation of Nonaqueous Electrolyte Solution)

A nonaqueous electrolyte solution was prepared in the same manner as that of Battery 1.

### (Fabrication of Battery)

A battery was fabricated in the same manner as Battery 1 except that resistance of PTC was controlled, and the component resistance was 16 mΩ. The fabricated battery was referred to as Battery I.

Table 3 shows the internal resistance of the battery, the resistance of the electrode group, the component resistance, the resistance value of the positive electrode, the amount of the conductive agent, the capacity of the electrode per unit area, the charge capacity of the negative electrode active material, the capacity ratio, the capacity retention rate, and battery capacity of each of Batteries 1, 7, A, and F-I.

TABLE 3

| | | | | Resistance | | | | | | |
|---|---|---|---|---|---|---|---|---|---|---|
| | Internal | Resistance of | | value of | Amount of | Capacity | | | Capacity | |
| | resistance of | electrode | Component | positive | conductive | per unit | Charge | Capacity | retention | Battery |
| | battery | group | resistance | electrode | agent | area | capacity | ratio | rate | capacity |
| Battery | mΩ | mΩ | mΩ | mΩ · cm² | wt % | mAh/cm² | mAh/g | % | % | Ah |
| Battery 1 | 45 | 25 | 20 | 0.2 | 1.25 | 3.5 | 320 | 75 | 75 | 2.8 |
| Battery 7 | 45 | 27 | 18 | 0.2 | 1.25 | 7.0 | 320 | 75 | 65 | 3.3 |
| Battery A | 35 | 20 | 15 | 0.05 | 3.0 | 3.5 | 320 | 90 | 40 | 2.8 |
| Battery F | 35 | 22 | 13 | 0.05 | 3.0 | 7.0 | 320 | 90 | 30 | 3.3 |
| Battery G | 45 | 28 | 17 | 0.2 | 1.25 | 7.5 | 320 | 75 | 30 | 3.35 |
| Battery H | 45 | 24 | 21 | 0.2 | 1.25 | 3.0 | 320 | 75 | 75 | 2.7 |
| Battery I | 35 | 19 | 16 | 0.05 | 3.0 | 3.0 | 320 | 90 | 75 | 2.7 |

### —Comparison—

### (Comparison Between Battery 7 and Battery G)

The capacity of the electrode per unit area of Battery 7 is 7.0 mAh/cm². The capacity of the electrode per unit area of Battery G is 7.5 mAh/cm². The battery capacity of Battery 7 is lower than that of Battery G. The capacity retention rate of Battery 7 is higher than that of Battery G.

The internal resistance of Battery 7 is the same as that of Battery G. The capacity ratio of Battery 7 is the same as that of Battery G. The charge capacity of the negative electrode active material of Battery 7 is the same as that of Battery G. The capacity retention rate of Battery G is lower than that of Battery 7. A presumable reason for this result is as follows. The capacity of the electrode per unit area of Battery G is higher than that of Battery 7. As the capacity of the electrode per unit area increases, the charge capacity becomes uneven in the direction of thickness of the electrode, and the cycle characteristic of the battery is reduced. The “uneven charge battery” designates that the capacity of the positive electrode or the negative electrode varies among parts thereof.

This indicates that the capacity of the electrode per unit area is preferably lower than 7.5 mAh/cm² (7.0 mAh/cm² or lower).

### (Comparison Between Battery 1 and Battery H)

The capacity of the electrode per unit area of Battery 1 is 3.5 mAh/cm². The capacity of the electrode per unit area of Battery H is 3.0 mAh/cm². The battery capacity of Battery 1 is higher than that of Battery H.

The internal resistance of Battery 1 is the same as that of Battery H. The capacity ratio of Battery 1 is the same as that of Battery H. The charge capacity of the negative electrode active material of Battery 1 is the same as that of Battery H. The capacity retention rate of Battery 1 is the same as that of Battery H.

Like Battery 1, Battery H shows the capacity ratio in the range of 50% to 85%, both inclusive, and Battery H shows high capacity retention rate like Battery 1. However, since the capacity of the electrode per unit area of Battery H is 3.0 mAh/cm² (lower than 3.5 mAh/cm²), the battery capacity of Battery H is lower than that of Battery 1. Thus, high battery capacity cannot be obtained.

This indicates that the capacity of the electrode per unit area is preferably higher than 3.0 mAh/cm² (3.5 mAh/cm² or higher).

This indicates that the capacity of the electrode per unit area is preferably in the range of 3.5 mAh/cm² to 7.0 mAh/cm², both inclusive.

### (Comparison Between Battery A and Battery I)

The capacity of the electrode per unit area of Battery A is 3.5 mAh/cm². The capacity of the electrode per unit area of Battery I is 3.0 mAh/cm². The battery capacity of Battery A is higher than that of Battery I. The capacity retention rate of Battery A is lower than that of Battery I.

The internal resistance of Battery A is the same as that of Battery I. The capacity ratio of Battery A is the same as that of Battery I. The charge capacity of the negative electrode active material of Battery A is the same as that of Battery I.

Like Battery A, Battery I shows the capacity ratio of 90% (higher than 85%). The capacity retention rate of Battery I is higher than that of Battery A. However, since the capacity of the electrode per unit area of Battery I is 3.0 mAh/cm² (lower than 3.5 mAh/cm²), the battery capacity of Battery I is lower than that of Battery A. Thus, high battery capacity cannot be obtained.

This indicates that the cycle characteristic of Battery A having high battery capacity may be reduced when the capacity ratio is 90% (higher than 85%). However, the cycle characteristic of Battery I having low battery capacity is not reduced when the capacity ratio is 90% (higher than 85%). Specifically, it is important to control the capacity ratio to 50% to 85%, both inclusive, to reduce the reduction in cycle characteristic of the battery having high battery capacity.

### (Batteries A and F)

Each of Batteries A and F has the capacity of the electrode per unit area in the range of 3.5 mAh/cm² to 7.0 mAh/cm², both inclusive. That is, Batteries A and F are high capacity batteries. Although Batteries A and F are high capacity batteries, they have the capacity ratio of 90% (higher than 85%), and low capacity retention rate. This reduces the cycle characteristic of the batteries.

### (Comparison Between Battery 1 and Batteries 7 and G)

In Battery 1, the capacity of the electrode per unit area is 3.5 mAh/cm², and the resistance of the electrode group is 25 mΩ. In Battery 7, the capacity of the electrode per unit area is 7.0 mAh/cm², and the resistance of the electrode group is 27 mΩ. In Battery G, the capacity of the electrode per unit area is 7.5 mAh/cm², and the resistance of the electrode group is 28 mΩ.

This indicates that the resistance of the electrode group increases with the increase in capacity of the electrode per unit area.

### (Comparison Between Battery 1 and Battery H)

In Battery 1, the capacity of the electrode per unit area is 3.5 mAh/cm², and the resistance of the electrode group is 25 mΩ. In Battery H, the capacity of the electrode per unit area is 3.0 mAh/cm², and the resistance of the electrode group is 24 mΩ.

This indicates that the resistance of the electrode group decreases with the decrease in capacity of the electrode per unit area.

### INDUSTRIAL APPLICABILITY

The present invention can reduce the reduction of the cycle characteristic of the nonaqueous electrolyte secondary battery having high battery capacity even when the battery is quickly charged. Thus, the present invention is useful for the nonaqueous electrolyte secondary battery, and a method for charging the battery.

### DESCRIPTION OF REFERENCE CHARACTERS

1 Positive electrode
2 Negative electrode
3 Porous insulating layer
4 Electrode group
5 Upper insulator
6 Lower insulator
7 Gasket
8 Sealing plate
9 Battery case
10 First positive electrode sample
20 Second positive electrode sample
10a, 20a Positive electrode current collector
10b, 20b Positive electrode mixture layer

1. A nonaqueous electrolyte secondary battery comprising:
a positive electrode including a positive electrode current collector, and a positive electrode mixture layer which is provided on a surface of the positive electrode current collector, and contains a positive electrode active material;
a negative electrode including a negative electrode current collector, and a negative electrode mixture layer provided on a surface of the negative electrode current collector;
a porous insulating layer arranged between the positive electrode and the negative electrode; and
a nonaqueous electrolyte solution, wherein
when the battery is charged in an environment of 25° C. at a constant current of 0.7 C until a voltage value reaches 4.2 V, and is charged at a constant voltage of 4.2 V until a current value decreases to 0.05 C, capacity of the electrode per unit area is 3.5 mAh/cm² to 7.0 mAh/cm², both inclusive, and charge capacity of the negative electrode active material is 300 mAh/g to 330 mAh/g, both inclusive, and
internal resistance of the battery is controlled in such a manner that the voltage value reaches 4.2 V when the battery is charged to 50% to 85%, both inclusive, of standard capacity in the environment of 25° C. at the constant current of 0.7 C.

2. The nonaqueous electrolyte secondary battery of claim 1, wherein
the internal resistance of the battery is 40 mΩ to 55 mΩ, both inclusive.

3. The nonaqueous electrolyte secondary battery of claim 1, wherein
when the positive electrode is removed from the charged nonaqueous electrolyte secondary battery to form a first positive electrode sample and a second positive electrode sample, and the positive electrode mixture layer of the first positive electrode sample and the positive electrode mixture layer of the second positive electrode sample are brought into contact with each other, a resistance value between a terminal attached to the positive electrode current collector of the first positive electrode sample, and a terminal attached to the positive electrode current collector of the second positive electrode sample is 0.2 Ω·cm² or higher.

4. The nonaqueous electrolyte secondary battery of claim 3, wherein
the resistance value is 0.2 Ω·cm² to 4.0 Ω·cm², both inclusive.

5. The nonaqueous electrolyte secondary battery of claim 4, wherein
the positive electrode contains 100 parts by mass of the positive electrode active material, and 0.2 parts by mass to 1.25 parts by mass, both inclusive, of carbon.

6. The nonaqueous electrolyte secondary battery of claim 5, wherein
the positive electrode mixture layer includes the positive electrode active material, and a conductive agent,
the conductive agent contains the carbon, and
the positive electrode contains 100 parts by mass of the positive electrode active material, and 0.2 parts by mass to 1.25 parts by mass, both inclusive, of the conductive agent.

7. The nonaqueous electrolyte secondary battery of claim 6, wherein
the positive electrode active material includes LiNi_{0.82}Co_{0.15}Al_{0.03}O₂, and
the conductive agent includes acetylene black.

8. A method for charging the nonaqueous electrolyte secondary battery of claim 1 at a constant current and a constant voltage, wherein
a constant current value for the charge at the constant current is 0.7 C or higher, and a constant voltage value for the charge at the constant voltage is 4.1 V or higher.
